(19) United States
(12) Patent Application Publication
(10) Pub. No.: US 2024/0242329 A1
(43) Pub. Date: Jul. 18, 2024

(54) Ensemble of Narrow AI agents for Manufacturing

(71) Applicant: Al QUALISENSE 2021 LTD, Tel Aviv-Yafo (IL)

(72) Inventor: Karina Odinaev, Tel Aviv (IL)

(73) Assignee: AI QUALISENSE 2021 LTD, Tel Aviv-Yafo (IL)

(21) Appl. No.: 18/415,940

(22) Filed: Jan. 18, 2024

Related U.S. Application Data
(60) Provisional application No. 63/480,486, filed on Jan. 18, 2023.

(51) Int. Cl. G06T 7/00

(52) U.S. Cl. CPC G06T 7/0004; G06T 2207/20081; G06T 2207/20084

(57) ABSTRACT

A method for A method for operating an ensemble of narrow AI agents related to a manufactured item (MI), the method includes obtaining one or more images of an evaluated MI; determining, by a relevancy determination unit and based on the one or more images, one or more relevant narrow AI agents of the ensemble that are relevant to a processing of the one or more images; wherein the ensemble is relevant to a first plurality of MI states; processing the one or more images, by the one or more relevant narrow AI agents, to provide one or more narrow AI agent MI related outputs; wherein each narrow AI agent is relevant to a respective fraction of the first plurality of MI states; and processing, by a MI evaluation unit, the one or more narrow AI agent MI related outputs decisions to provide an MI related evaluation.

### BACKGROUND

The evaluation of manufactured items is highly complex—especially when there is a need to assess inter-defect variation and intra-defect variability.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a system;

FIG. 2 illustrates an example of a method; and

FIG. 3 illustrates an example of a step of the method of FIG. 4;

FIG. 4 illustrates an example of a Multi-Level Hierarchical Router; and

FIGS. 5-7 illustrates example of images, some of which include defects.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

Any one of the perception unit, narrow AI agents, MI evaluation unit may be implemented in hardware and/or code, instructions and/or commands stored in a non-transitory computer readable medium, may be included in a manufactured item, outside a manufactured item, in a mobile device, in a server, and the like.

The manufactured item may be any type of manufactured item that a ground transportation manufactured item, an airborne manufactured item, and a water vessel.

The specification and/or drawings may refer to an image. An image is an example of a media unit. Any reference to an image may be applied mutatis mutandis to a media unit. A media unit may be an example of sensed information. Any reference to a media unit may be applied mutatis mutandis to any type of natural signal such as but not limited to signal generated by nature, signal representing human behavior, signal representing operations related to the stock market, a medical signal, financial series, geodetic signals, geophysical, chemical, molecular, textual and numerical signals, time series, and the like. Any reference to a media unit may be applied mutatis mutandis to sensed information. The sensed information may be of any kind and may be sensed by any type of sensors—such as a visual light camera, an audio sensor, a sensor that may sense infrared, radar imagery, ultrasound, electro-optics, radiography, LIDAR (light detection and ranging), etc. The sensing may include generating samples (for example, pixel, audio signals) that represent the signal that was transmitted, or otherwise reach the sensor.

The specification and/or drawings may refer to a spanning element. A spanning element may be implemented in software or hardware. Different spanning element of a certain iteration are configured to apply different mathematical functions on the input they receive. Non-limiting examples of the mathematical functions include filtering, although other functions may be applied.

The specification and/or drawings may refer to a concept structure. A concept structure may include one or more clusters. Each cluster may include signatures and related metadata. Each reference to one or more clusters may be applicable to a reference to a concept structure.

The specification and/or drawings may refer to a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

Any combination of any steps of any method illustrated in the specification and/or drawings may be provided.

Any combination of any subject matter of any of claims may be provided.

Any combinations of systems, units, components, processors, sensors, illustrated in the specification and/or drawings may be provided.

Any reference to an object may be applicable to a pattern. Accordingly—any reference to object detection is applicable mutatis mutandis to a pattern detection.

An MI state is a state of at least one portions of the MI. The state may indicate the manner that the MI (or one or more portions thereof) appear in an image, and/or defect related to the MI or to one or more AI portions.

The sensed information unit may be sensed by one or more sensors of one or more types. The one or more sensors may belong to the same device or system—or may belong to different devices of systems.

A relevancy determination unit may be provided and may be preceded by the one or more sensors and/or by one or more interfaces form receiving one or more sensed information units. The relevancy determination unit may be configured to receive a sensed information unit from an I/O interface and/or from a sensor. The relevancy determination unit may be followed by multiple narrow AI agents—also referred to an ensemble of narrow AI agents.

The ensemble of narrow AI agents may include hierarchical structure of AI agents, and the relevancy determination unit may be a multi-level hierarchical unit such as Multi-Level Hierarchical Router (MLHR).

The Multi-Level Hierarchical Router iteratively divides a larger task into less complex sub tasks, in the world of manufacturing these sub tasks may include inter-defect variations, intra-non-defected variations and/or intra-defect variations and the like. For example—detect anomality such as chip offs based on spatial location, shape, color, texture, size etc. Once each sub task has been identified the router will assign the problem to an agent that is an “expert” at solving the assigned sub task.

The function of the MLHR is to divide and subdivide the complex tasks and subtasks into manageable, lower level, subtasks that can be completed with high competency by specialist “expert” agents that are dedicated to a single lower level task.

Furthermore, the MLHR is also be able to route between any given complex data input to its relevant expert agents for successful task completion.

Methods that may be used in the MLHR for subtask division may include, one or a combination of, but are not limited to: location specific division of input, signal-to-noise-ratio, intelligent agent feature extractor, clustering algorithms, classification techniques and/or classical computer vision techniques etc.

In a MI state where the MLHR identifies multiple agents to solve the given subproblem/s an ensemble may be created by which the specialized knowledge of the relevant agent may be consulted and pooled so that a more holistic decision can be made. The pooling process may include but is not limited to: majority voting, plurality voting (plurality rule), using the Hare system, using the Coombs system, approval voting, using the Borda count, using the runoff system, using the Condorcet criterion.

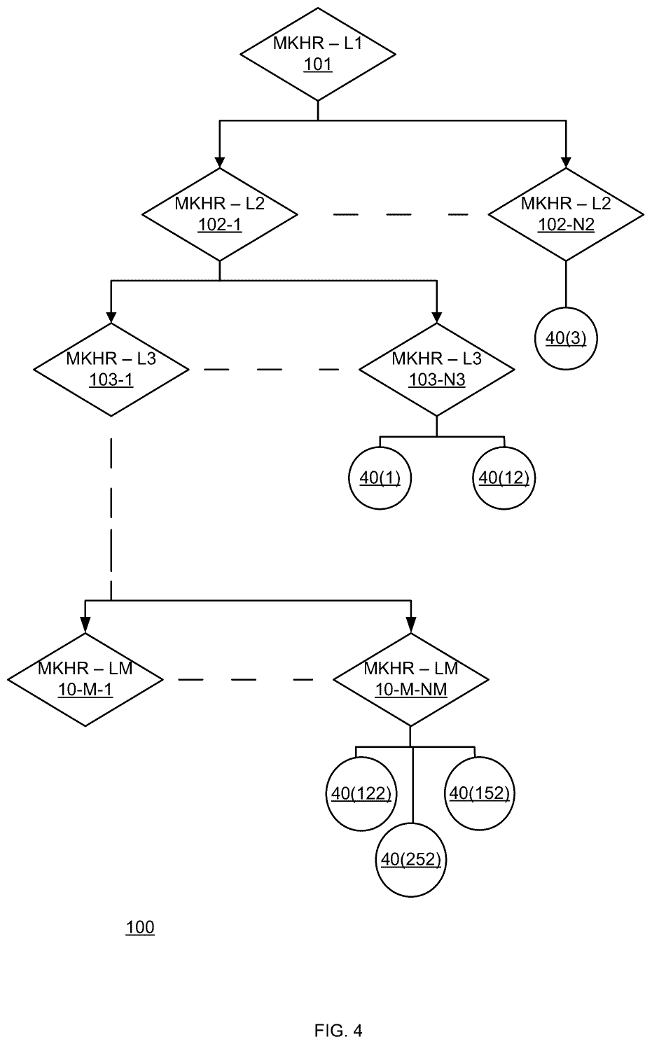

See—for example FIG. 4 illustrating a multi-level hierarchical relevancy determination unit 100 that includes M levels—the first level includes relevancy determination sub-unit MLHR-L1 101, the second level includes relevancy determination sub-units MLHR-L2 102-1-102-N2, the third level includes relevancy determination sub-units MLHR-L3 103-1-103-N3, and the M′th level includes relevancy determination sub-units MLHR-LM 10-M-1-10-M-NM, whereas at least some of the relevancy determination sub-units are associated with (route to) narrow AI agents such as 40(1), 40(3), 40(12), 40(122), 40(152) and 40(252).

An artificial intelligence (AI) agent may refer to an autonomous entity which acts, directing its activity towards achieving goals (i.e. it is an agent), upon an environment using observation through sensors and consequent actuators (i.e. it is intelligent). Intelligent agents may also learn or use knowledge to achieve their goals. They may be very simple or very complex. A reflex machine, such as a thermostat, is considered an example of an intelligent agent (www.wikipedia.org).

A sensed information unit may or may not be processed before reaching the relevancy determination unit. Any processing may be providing—filtering, noise reduction, and the like.

The number of narrow AI agents may, for example—exceed 100, exceed 500, exceed 1000, exceed 10,000, exceed 100,000 and the like. Larger number of narrow AI agents may provide more accurate MI evaluations.

An AI narrow agent is narrow in the sense that it is not trained to respond to all possible (or all probable, or a majority of) MI states that should be dealt by the entire ensemble. For example—each AI narrow agent may be trained to respond to a fraction (for example less than 1 percent) of the MI states managed by the entire ensemble. A narrow AI agent may be trained to respond to only some factors or elements or parameters or variables that form a MI state.

The narrow AI agents may be of the same complexity and/or of same parameters (depth, energy consumption, technology implementation)—but at least some of the narrow AI agents may differ from each other by at least one of complexity and/or parameters.

The narrow AI agents may be trained in a supervised manner and/or non-supervised manner.

One or more narrow AI agents may be a neural network or may differ from a neural network.

The narrow AI agents may be task specific experts that have either been trained or designed with the successful completion of a specific low-level task.

The complexity of the narrow AI agents may vary from a simple gradient of image computation to using a pre-trained generic feature extractor to training a highly customized and novel neural network model trained in a domain-specific manner. The complexity of the narrow AI agent's decision making will be relative to the complexity of the subtask in which it is specializing.

The ensemble may include one or more sensors and any other entity for generating a sensed information unit and/or may receive (by an interface) one or more sensed information units from the one or more sensors.

The relevancy determination unit may process the one or more sensed information units and determine which narrow AI agents are relevant to the processing of the one or more sensed information units.

There may be provided an autonomous manufactured item system that may use the relevancy determination unit to classify the observed scene into multiple coarse grained categories. The system may include an ensemble of narrow AI agents (EoN).

The relevancy determination unit may receive and/or generate anchors that once detected (by the perception unit), may affect the selection of which narrow AI agents to select. The number of anchors may be very big (for example—above 100, 500, 1000, 10,000, 20,000, 50,000, 100,000 anchors and even more).

For a given MI state (may be represented by one or more sensed information units such as but not limited to one or more images), the relevancy determination unit may detect one or more anchors.

The detected anchors may provide sufficient contextual cues to allow the relevancy determination unit to determine which are the relevant narrow AI agents.

The contextual cue may be a high-level sensed information unit context. It is high level in the sense that the determining of the contextual cue is less complex and/or requires less computational resources than performing object detection of a small element in a sensed information unit. A small element may be of a minimal size to be detected, may be, for example of a size of a few tens of pixels, may be of a size that is smaller than 0.1, 0.5, 1, 2, 3 percent of the sensed information unit, and the like. The determining of the contextual cue may not, for example, include determining the exact locations of each element in the image—including the locations of elements that appear as few tens of pixels in an image.

By searching for high-level sensed information unit context, the power consumption of the relevancy determination unit may be much lower (for example even up to two orders of magnitude lower) than the power consumption of a prior art system that is built to perform the entire process of object detection, and determining which driving operation to perform).

At least some of the power savings can be attributed to the fact the high-level sensed information unit context may not include location information, there is no need to determine whether elements of different sizes are the same type of elements, and the like.

A narrow AI agent may receive input directly from the sensors (for example—as an output of the relevancy determination unit) and provides as an MI related output indicative of the state of the MI (or of at least one or more portions of the MI).

The MI related outputs from the different selected narrow AI agents are fed to a MI evaluation unit (also referred to as coordinator) that outputs an one or more output MI evaluations.

The coordinator may apply any method for generating one or more output MI evaluations such as the one or more commands and requests based on the outputs from the different selected narrow AI agents.

These methods may include arbitration, competition, selecting a response based on a risk imposed by adopting an output of a narrow AI agent, and the like.

Referring back to the relevancy determination unit—non-limiting examples of anchors are listed below.

The anchors may be selected, generated and/or learnt in various manners-manually, automatically, based on human tagging of inputs, based on autonomous tagging of inputs, based on manually identification, based on tagging of MI states.

A first example of generating corner MI chip off anchors is illustrated below.
Splitting images of test MIs into Patches (Group of pixels grouped together based on their spatial location).
Perform one of the following:
   i. Clustering and filtering the patches by color into dark and bright patches—for example—keeping only darker patches (assuming that such patches may be indicative of chip off).
   ii. Identification and filtering by morphological shapes present in patches (such as: square, triangle, circles or jagged line)—the method may choose to keep patches that contain shapes that share morphological properties with triangles and/or jagged lines.
   iii. Identification and filtering by textural properties present in image (such as: diagonal lines following gradients in a particular range, wavy lines). The method may choose to keep only patches that contain diagonal lines with gradients in a particular range.

A second example of generating corner MI chip off anchors is illustrated below.
Splitting images of test MIs into Patches (Group of pixels grouped together based on their spatial location).
·Perform one of the following:
   i. Filtering based on the spatial location of the patch, where the method has prior knowledge that chip offs often occur on the magnet corners—therefore the method may only keep patches that fulfill this prior knowledge criterion.
   ii. Running inference on the remaining patches through the concept logic. The method may choose to keep on those patches that are assigned a positive prediction (NG) by the concept logic.
   iii. Filtering based on patch mean values as the method may choose to only keep those patches with higher mean grayscale pixel values.
   iv. Reintroduce and Include patches that are adjacent to those patches that pass the all the above criterion.

A narrow AI agent may be or may include a simple model (for example—a neural network) that receives raw (or pre-processed in any manner) sensor data as its input, processes it internally, and outputs a proposed behavior.

Examples of narrow AI agents are listed below:
Corner MI chip off.
Scratches.
Watermark.

Corner MI chip off. The definition of a narrow AI agents for detecting corner MI chip off may include Obtaining an input image and split it into patches (such as 64 by 64 pixels—other sizes may be applied mutatis mutandis). Using OK and No Good mining procedure to provide OK and NG clusters. Repeat iteratively until a certain predefined number of clusters and/or cluster sizes is reached. Thereby subdividing into clusters that contain lower variability in their feature representations. At least on cluster may include one or more segments of a corner MI chip off. A cluster signature of the cluster may be generated and be compared (when detecting corner MI chip off—to signature of evaluated MI image patches—to find the corner MI chip off. Yet for another example—the narrow AI agent may be a Canny Edge Detector.

Scratches. In a manufactured product where the structural/functional integrity may be compromised by vertical scratches and not by horizontal ones it may become an integral sub-task to discriminate between vertical and horizontal scratches.

The MLHR may have an initial level of a defect detector being deployed using a low detection threshold so that to classify a higher proportion of the actual defects whilst also predicting many false positives. This process may be done iteratively at each step the detection threshold may increase incrementally. Until a predefined stopping condition is met (for example until a given detection threshold is reached).

The narrow AI agent may comprise of a solution such as deploying a pre-trained object detector that was trained on a generic benchmark in a similar domain to predict bounding boxes on the suspected scratches, The detector would output bounding boxes where it believes scratches exist. It is then a simple task to compute whether the box predicted by the detector is bounding a vertical or horizontal scratch.

Watermarks is a common challenge in the world of manufacturing. Whilst it may look like a defect at first glance, as it does not compromise the structural/functional integrity of the product it is considered to NOT be a defect. An initial level MLHR may include but not limited to classical computer vision techniques such as edge detection and defect level morphology in addition to the OK and NG mining procedure to cluster into OK and NG clusters. A narrow AI agent solution would be to train a model to discriminate between watermarks and other similar noise/defects. This can be done by training an encoder decoder model to reconstruct the image using self-supervised techniques. Given that we trained the encoder decoder model on OK patches only we would expect the model would have learnt to reconstruct images that follow the distribution of OK images only (amongst those are also watermarks) and would struggle to reconstruct details that follow different distributions (such as NG). Therefore, at inference when we take the difference of the input image and reconstructed image we should get high error values at areas which are actual defects whereas in areas where only noise is present (such as watermark) we should get a lower error value.

The system is expected to be superior to SD systems in all aspects, whether it is behavioral accuracy, model size and complexity, and computational intensity.

The relevancy determination unit may work in a more efficient manner than state of the art perception systems. State of the art perception systems must “cover” all possible combination of states of MI and/or states of one or more portions of the MI.

This is very power and resources consuming process.

A relevancy determination unit does not need to concentrate on all the details, and identify every agent—it only needs to analyze and classify the scene only in order to activate the relevant agent. This is a very light process performance-wise. The relevant agent, once activated, will analyze the relevant features of the input image.

It should be noted that even when the number of narrow AI agents is large—some may be stored in RAM and others may be saved in non-volatile memory (for example in disks, in cheap non-volatile memory, and the like)—and can be retrieved when needed.

The relevancy determination unit may be very fast as it tasks is to detect anchors and based on the anchors—selecting the relevant narrow AI agents. Each narrow AI agent may also very fast, however, we have a very large number of these. Lucky, at any given point only few of them need to actually run, i.e., at any given point of time the running time is very small.

The suggested units may be executed or hosted by a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

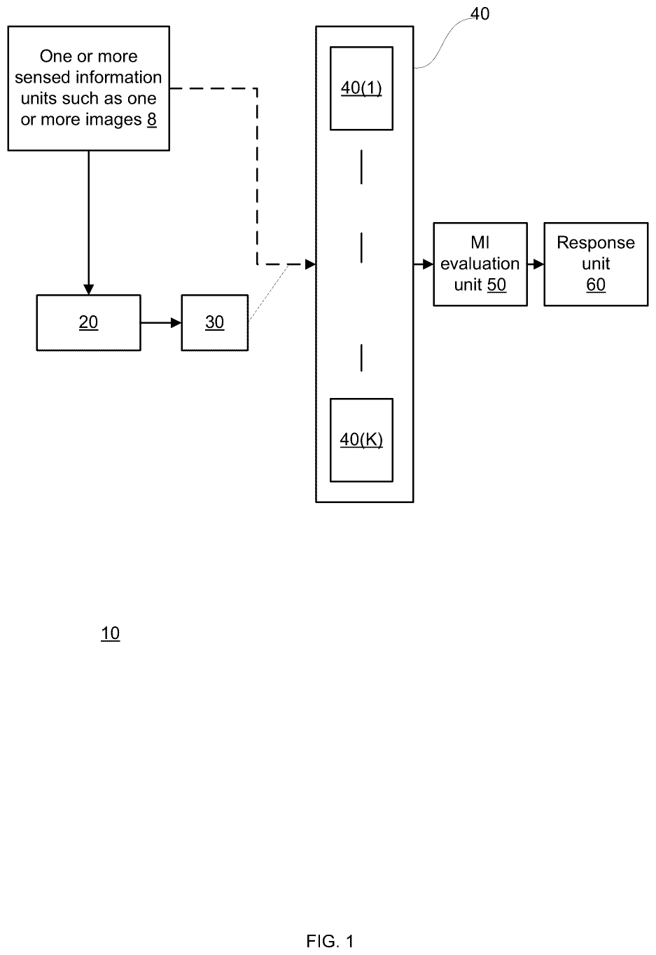

FIG. 1 illustrates an example of a system 10.

System 10 includes an obtaining unit 20 (for obtaining one or more sensed information units such as one or more images 8), a relevancy determination unit such as perception router 30, an ensemble 40 narrow AI agents, and a MI evaluation unit such as coordinator 50. The MI evaluation unit 50 may control and/or may communicate with a response unit 60.

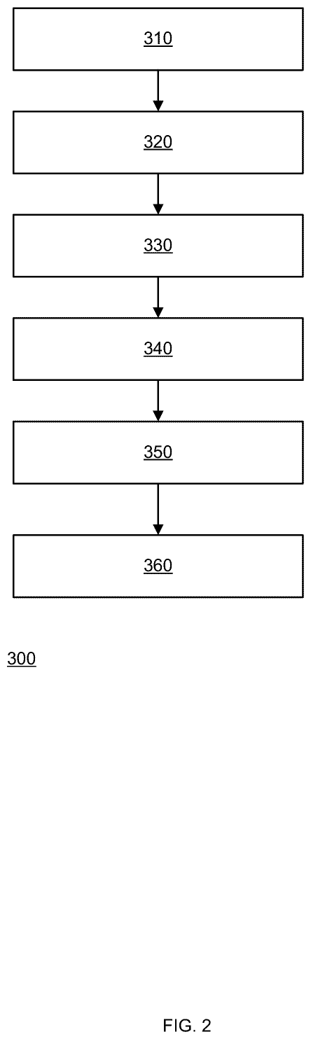

FIG. 2 illustrates method 300 for operating an ensemble of narrow AI agents related to a manufactured item.

The method may include various steps, some may include providing desired MI evaluations (for example during a training of any part of the entities used during method 300, the entities may include a perception unit, narrow AI agents, and a MI evaluation unit).

Additionally or alternatively, MI evaluations associated with any of the sensed information units fed to any of the entities may be provided and the method may include determining which MI evaluations were correct one. For example—this may be determined using statistics—for example adopting the most common driving decision per situation and/or MI state, or any par therein.

Method 300 may start an initialization step 310.

Step 310 may include obtaining a perception unit, narrow AI agents and a MI evaluation unit configured to execute various steps of method 300.

The obtaining may include receiving after being trained, and/or training and/or receiving at any stage of the training process, downloading instructions or otherwise configuring a computerized system to execute any other step of method 300.

Step 310 may include at least one of (a) training at least one of the perception unit, the narrow AI agents, and the MI evaluation unit, (b) receiving at least one of already trained perception unit, the narrow AI agents, and the MI evaluation unit, (c) otherwise configuring the at least one of the perception unit, the narrow AI agents, and the MI evaluation unit.

Step 310 may be followed by step 320 of obtaining one or more sensed information units.

The obtaining may include sensing, receiving without sensing, preprocessing, and the like.

Step 320 may be followed by step 330 of determining, by a relevancy determination unit and based on the one or more sensed information units, one or more relevant narrow AI agents of the ensemble that may be relevant to a processing of the one or more sensed information units. The entire ensemble may be relevant to a first plurality of MI states.

Each relevant narrow AI agent may be relevant to a dedicated class. The class may be associated with an anchor. Step 330 may include searching for the anchor.

Each class may be defined by at least a part of one or more MI states, wherein the at least part of the one or more MI states may be a fraction of the first plurality of MI states. At least some of the multiple classes may be different classes of MI anomalies.

Non-limiting examples of classes of MI anomalies includes at least one out of (a) a MI corner chip off class, (b) one or more MI scratch classes, and/or (c) one or more MI watermark classes.

Examples of one or more one or more MI scratch classes may include (i) MI scratch classes that differ from each other by an orientation of a scratch, such as (ii) a vertical MI scratch class and a horizontal MI scratch class.

The different narrow AI agents may be trained to respond to different MI states that may be (or may include) an OK MI, a defected MI, a MI that includes one or more defective portions and/or one or more other OK portions, whereas the detects may be of any class.

Each class may be defined by an anchor that may be a contextual cue.

The narrow AI agents may be end-to-end narrow AI agents.

For at least some of the narrow AI agents, the respective fraction may be smaller than one percent of the first plurality of MI states.

Step 330 may be followed by step 340 of sending the one or more sensed information units to the relevant narrow AI agents.

It should be noted that once the one or more relevant narrow AI agents are determined they may be uploaded to a processor and/or a memory unit. This reduces the RAM or other memory resources required to store and execute step 350.

Step 340 (or method 300) may include maintaining at least one irrelevant narrow AI agent in a low power mode (idle, inactivated, in sleep mode, partially operational, and the like) in which a power consumption of the at least one irrelevant narrow AI agent may be lower than a power consumption of a relevant narrow AI agent.

Step 340 may be followed by step 350 of processing the one or more sensed information units, by the one or more relevant narrow AI agents, to provide one or more narrow AI agent MI evaluations. Each narrow AI agent may be relevant to a respective fraction of the first plurality of MI states managed by the entire ensemble.

Step 350 may be followed by step 360 of processing, by a MI evaluation unit, the one or more narrow AI agent MI evaluations to provide an MI related evaluation.

Step 360 may include averaging the one or more narrow AI agent MI evaluations, or applying one or more functions (for example—predefined and/or learnt and/or change over time), and/or applying one or more policies on the one or more narrow AI agent MI evaluations.

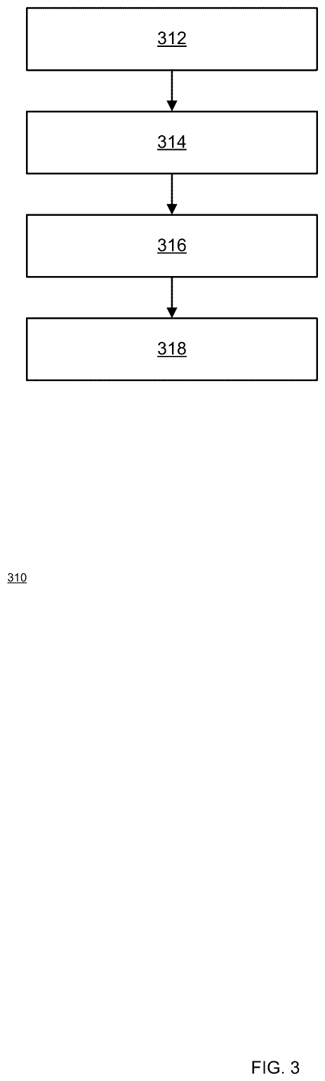

FIG. 3 illustrates an example of step 310.

Step 310 may include step 312 of training the relevancy determination unit to classify sensed information units to classes.

Each class may be at least a part of one or more MI states, the one or more MI states may be a fraction of the first plurality of MI states.

Each class may be associated by an anchor. The anchor may be used to classify a sensed information unit to the class.

Step 312 may include receiving, by the relevancy determination unit a definition of at least some of the classes before training. This may include, for example, receiving labels or any other class defining information.

Step 312 may include defining, by the relevancy determination unit at least some of the classes.

The defining may include, for example generating signatures, and clustering the signatures to concept structures such as clusters. The clustering virtually define the classes.

The clusters may all belong to the same level or may be arranged in a hierarchical manner. The clustering, inherently, may be responsive to the statistics of the contextual cues—more frequently occurring contexts may be segmented to more clusters. Larger clusters may be split to clusters of lower level—in any manner—for example by cross correlation between cluster members, by finding shared signatures portions and unique signature portions, and the like.

Step 312 may include performing an unsupervised training.

At least part of one or more MI states may be at least one out of (a) one or more factors of a MI state, (b) one or more element of a MI state, (c) one or more parameters of a MI state, and (d) one or more variables of a MI state.

Step 312 may be include feeding the relevancy determination unit with a first dataset of sensed information units.

Step 312 may be followed by step 314 of using the trained relevancy determination unit to classify sensed information units of a second dataset. There sensed information units are referred to as second sensed information units.

Step 314 may also include feeding one or more MI evaluations per class.

Each class will include multiple second sensed information units and one or more MI evaluation.

Each narrow AI agent may be associated with a dedicated class. Step 314 may be followed by step 316 of training each narrow AI agent to output a narrow AI agent MI related output associated with the dedicated class.

The training of step 316 may include feeding a narrow AI agent associated with a given class with second sensed information and one or more MI related evaluations of the class.

Step 316 may be executed in a supervised or non-supervised manner. A supervised training may include providing one or more MI related evaluations as the requested output of the narrow AI agent.

Step 316 may be followed by step 318 of training the MI evaluation unit to provide an output MI related evaluations based on one or more narrow AI agent MI evaluations.

Step 318 may include feeding sensed information units of the third dataset (hereinafter third sensed information units) to the relevancy determination unit, allowing the relevancy determination unit to determine the relevant narrow AI classes (based on the classes of the third sensed information units), allow the relevant narrow AI classes to output narrow AI agent MI evaluations and feed the MI evaluation unit with the narrow AI agent MI evaluations and MI evaluations associated with the third dataset.

Each one or the first, second, and third datasets may include any number of sensed information unit, may be generated in any manner. They may include randomly selected sensed information unit- or any combination of sensed information units.

There may be provided a non-transitory computer readable medium that may store instructions for operating an ensemble of narrow AI agents, the operating may include obtaining one or more sensed information units; determining, by a relevancy determination unit and based on the one or more sensed information units, one or more relevant narrow AI agents of the ensemble that are relevant to a processing of the one or more sensed information units; wherein the ensemble is relevant to a first plurality of MI states; processing the one or more sensed information units, by the one or more relevant narrow AI agents, to provide one or more narrow AI agent MI evaluations; wherein each narrow AI agent is relevant to a respective fraction of the first plurality of MI states; and processing, by a MI evaluation unit, the one or more narrow AI agent MI evaluations to provide an MI related evaluation.

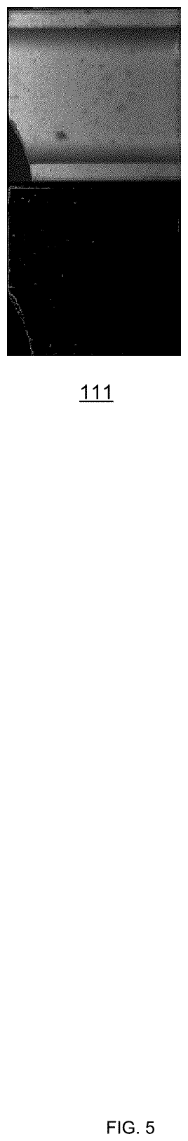

FIG. 5 illustrates an input image 111 and output images 112 that includes feature that are extracted by a narrow AI agent such as a Canny edge detector.

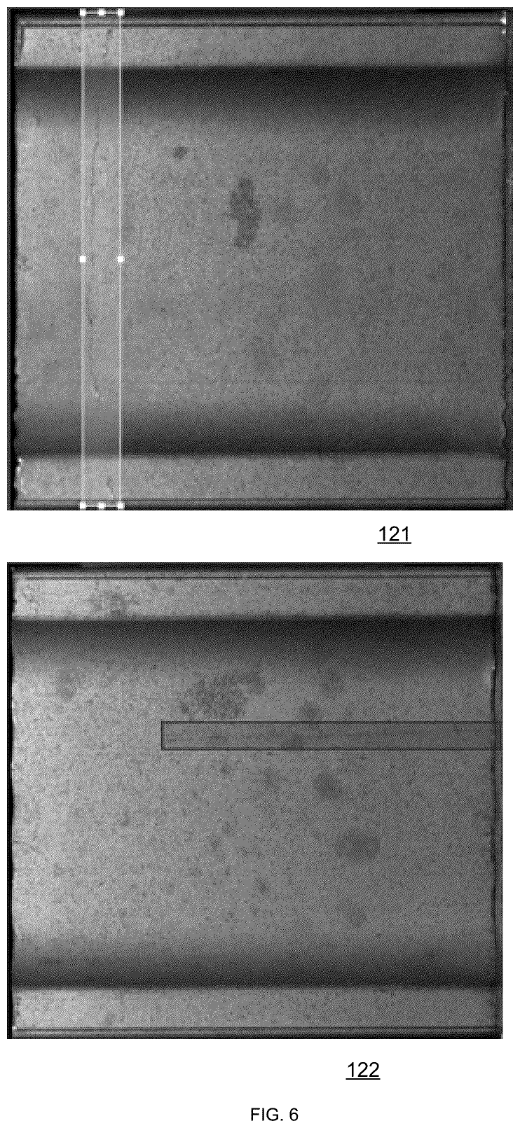

FIG. 6 illustrates an vertical scratch within a MI captured in image 121, and also illustrates a horizontal scratch within a MI captured by image 122.

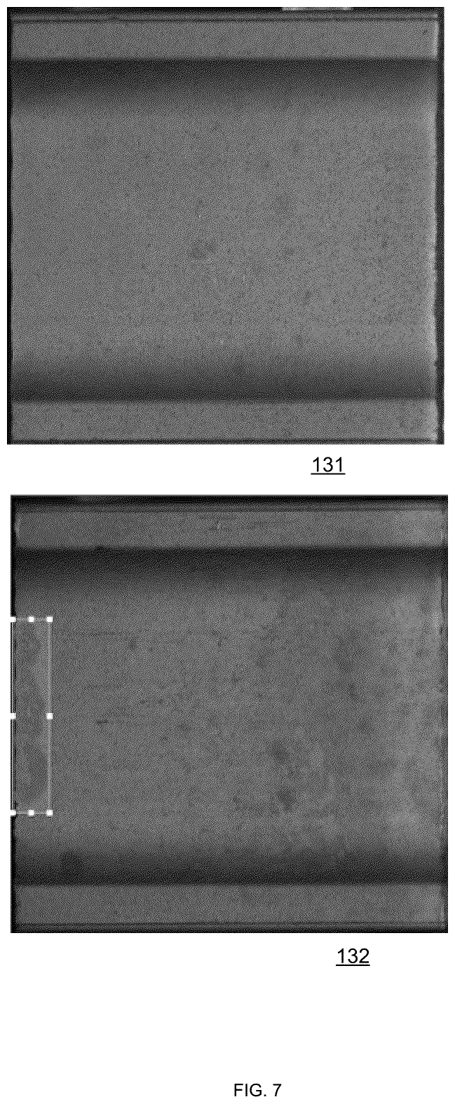

FIG. 7 illustrates an input image 131, and a watermark within a MI that is captured in image 132.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for operating an ensemble of narrow AI agents related to a manufactured item (MI), the method comprises:
obtaining one or more images of an evaluated MI;
determining, by a relevancy determination unit and based on the one or more images, one or more relevant narrow AI agents of the ensemble that are relevant to a processing of the one or more images; wherein the ensemble is relevant to a first plurality of MI states;
processing the one or more images, by the one or more relevant narrow AI agents, to provide one or more narrow AI agent MI related outputs; wherein each narrow AI agent is relevant to a respective fraction of the first plurality of MI states; and
processing, by a MI evaluation unit, the one or more narrow AI agent MI related outputs decisions to provide an MI related evaluation.

2. The method according to claim 1 wherein each relevant narrow AI agent is relevant to a dedicated class out of multiple classes, wherein at least some of the multiple classes are different classes of MI anomalies.

3. The method according to claim 2 wherein each class is defined by at least a part of one or more MI states, wherein the at least part of the one or more MI states are a fraction of the first plurality of MI states.

4. The method according to claim 2 wherein the different classes of MI anomalies comprise an MI corner chip off class.

5. The method according to claim 2 wherein the different classes of MI anomalies comprise one or more MI scratch classes.

6. The method according to claim 2 wherein the different classes of MI anomalies comprise MI scratch classes that differ from each other by an orientation of a scratch.

7. The method according to claim 2 wherein the different classes of MI anomalies comprise a vertical MI scratch class and a horizontal MI scratch class.

8. The method according to claim 2 wherein the different classes of MI anomalies comprise one or more MI watermark classes.

9. The method according to claim 1 wherein the ensemble of narrow AI agents comprises hierarchical structure of AI agents, and wherein the relevancy determination unit is a multi-level hierarchical unit.

10. The method according to claim 1 wherein the determining, by the relevancy determination unit, of one or more relevant narrow AI agents of the ensemble, is executed without detection of objects that are below a predefined number of pixels.

11. The method according to claim 1 wherein the relevancy determination unit is trained to classify images to classes, wherein each class is at least a part of one or more MI states, the one or more MI states are a fraction of the first plurality of MI states.

12. The method according to claim 11 comprising receiving, by the relevancy determination unit a definition of at least some of the classes before training.

13. The method according to claim 11 comprising defining, by the relevancy determination unit at least some of the classes.

14. The method according to claim 13 wherein the defining comprises performing an unsupervised training.

15. The method according to claim 11 wherein the at least part of one or more MI states is at least one out of (a) one or more factors of a MI state, (b) one or more element of a MI state, (c) one or more parameters of a MI state, and (d) one or more variables of a MI state.

16. The method according to claim 11 wherein each narrow AI agent is associated with a dedicated class and the method comprises training each narrow AI agent to output a narrow AI agent MI related output associated with the dedicated class.

17. The method according to claim 16 wherein the training comprises training each narrow AI agent using images of the dedicated class.

18. The method according to claim 1 wherein the narrow AI agents are end-to-end narrow AI agents.

19. The method according to claim 1 wherein for at least some of the narrow AI agents the respective fraction is smaller than one percent of the first plurality of MI states.

20. The method according to claim 1 wherein a number of narrow AI agents relevant to one of the first plurality of MI states differs from a number of narrow AI agents relevant to another of the first plurality of MI states.

21. The method according to claim 1 wherein a number of narrow AI agents exceeds one thousand.

22. The method according to claim 1 wherein a number of narrow AI agents is exceeds ninety nine thousand.

23. The method according to claim 1 wherein at least some of the narrow AI agents comprise at least a portion of a neural network.

24. The method according to claim 1 comprising feeding, by the relevancy determination unit the one or more images to each one of the one or more relevant narrow AI agents.

25. The method according to claim 1 comprising feeding, by the relevancy determination unit the one or more images to each one of the one or more relevant narrow AI agents and maintaining at least one irrelevant narrow AI agent in a low power mode in which a power consumption of the at least one irrelevant narrow AI agent is lower than a power consumption of a relevant narrow AI agent.

26. The method according to claim 1 comprising determining which part of the one or more images to send to each relevant narrow AI agent.

27. A non-transitory computer readable medium for operating an ensemble of narrow AI agents related to a manufactured item (MI), wherein the non-transitory computer readable medium stores instructions for:
obtaining one or more images of an evaluated MI;
determining, by a relevancy determination unit and based on the one or more images, one or more relevant narrow AI agents of the ensemble that are relevant to a processing of the one or more images; wherein the ensemble is relevant to a first plurality of MI states;
processing the one or more images, by the one or more relevant narrow AI agents, to provide one or more narrow AI agent MI related outputs; wherein each narrow AI agent is relevant to a respective fraction of the first plurality of MI states; and
processing, by a MI evaluation unit, the one or more narrow AI agent MI related outputs decisions to provide an MI related evaluation.

28. A system for operating an ensemble of narrow AI agents related to a manufactured item (MI), the system comprises:
an ensemble of narrow AI agents related to the MI;
a relevancy determination unit that is configured to determined, based on one or more images, one or more relevant narrow AI agents of the ensemble that are relevant to a processing of the one or more images; wherein the ensemble is relevant to a first plurality of MI states;
wherein the one or more relevant narrow AI agents are configured to process the one or more images, by the, to provide one or more narrow AI agent MI related outputs; wherein each narrow AI agent is relevant to a respective fraction of the first plurality of MI states; and
a MI evaluation unit, that is configured to process the one or more narrow AI agent MI related outputs decisions to provide an MI related evaluation.
